(19) United States
(12) Patent Application Publication
(10) Pub. No.: US 2021/0381383 A1
(43) Pub. Date: Dec. 9, 2021

(54) FLOW DIRECTING STRUCTURE FOR A TURBINE STATOR STAGE

(71) Applicant: Siemens Aktiengesellschaft, München (DE)

(72) Inventors: Jan H. Marsh, Orlando, FL (US); Evan C. Landrum, Charlotte, NC (US)

(21) Appl. No.: 16/322,751

(22) PCT Filed: Aug. 30, 2016
(86) PCT No.: PCT/US2016/049386

§ 371 Date: Feb. 1, 2019

(51) Int. Cl. F01D 5/14; F01D 5/18; F01D 9/04

(52) U.S. Cl. CPC F01D 5/147; F01D 5/189; F05D 2300/6033; F05D 2260/20; F01D 9/041

(57) ABSTRACT

A stator stage (10) of a turbine engine includes a circumferential row of flow directing structures (12), each including: an inner endwall (14) and an outer endwall (16) spaced apart radially, and a pressure sidewall (18) and a suction sidewall (20) extending radially between the inner endwall (14) and the outer endwall (16) and spaced apart circumferentially. The inner and outer endwalls (14, 16) and the pressure and suction sidewalls (18, 20) define therewithin a duct (22) for directing flow of a hot gas. Circumferentially adjacent flow directing structures (12a, 12b) mate along a respective split-line (24) extending along an interface between the pressure sidewall (18) of a first flow directing structure (12a) and the suction sidewall (20) of a second circumferentially adjacent flow directing structure (12b). A composite airfoil structure (26) is thereby defined having a pressure sidewall (18) formed by the pressure sidewall (18) of the first flow directing structure (12a) and a suction sidewall (20) formed by the suction sidewall (20) of the second flow directing structure (12b).

### BACKGROUND

### 1. Field

The present invention is directed generally to gas turbine engines, and more particularly to a flow directing structure in a turbine stator stage.

### 2. Description of the Related Art

In a turbomachine, such as a gas turbine engine, air is pressurized in a compressor section and then mixed with fuel and burned in a combustor section to generate hot combustion gases. The hot combustion gases are expanded within a turbine section of the engine where energy is extracted to power the compressor section and to produce useful work, such as turning a generator to produce electricity. The hot combustion gases travel through a series of turbine stages within the turbine section. A turbine stage may include a row of stationary airfoils, i.e., stator vanes, followed by a row of rotating airfoils, i.e., rotor blades, where the rotor blades extract energy from the hot combustion gases for providing output power. Since stator vanes and rotor blades are directly exposed to the hot combustion gases, they are typically provided with internal cooling channels. The internal cooling channels conduct a coolant, typically air bled from the compressor section, to absorb heat from the airfoil structure, especially the airfoil outer wall which is directly exposed to the hot combustion gases.

As shown in FIG. 1, a stator stage is typically made up of stator vane segments with each stator vane segment comprising one or more airfoils 2 extending between an inner shroud segment 6 and an outer shroud segment (not shown in FIG. 1). Each airfoil 2 typically includes internal cooling channels, which may be embodied, for example, as impingement cavities 8a, as depicted on the left stator vane segment of FIG. 1, or serpentine cooling channels 8b, as depicted on the right stator vane segment of FIG. 1, among other possible configurations. The stator vane segments are arranged circumferentially adjacent to each other to form the stator stage. Circumferentially adjacent stator vane segments mate along a split-line 7 located at the circumferential edges of the outer and inner shroud segments. The split-line 7 is typically located mid-way between adjacent airfoils 2. The volume between adjacent airfoils 2 forms a flow duct that suitably directs the flow of hot combustion gases toward a row of rotating turbine blades downstream of the stator stage.

In order to push gas turbine efficiencies even higher, there is a continuing drive to reduce coolant consumption in the turbine. For example, it is known to form turbine blades and vanes of ceramic matrix composite (CMC) materials, which have higher temperature capabilities than conventional superalloys, which makes it possible to reduce consumption of compressor air for cooling purposes.

### SUMMARY

Briefly, aspects of the present invention provide an alternate configuration of a flow directing structure for a turbine stator stage.

According a first aspect of the present invention, a stator stage for a turbine engine is provided, which comprises a circumferential row of flow directing structures. Each flow directing structure comprises an inner endwall and an outer endwall spaced apart in a radial direction of the turbine engine, and a pressure sidewall and a suction sidewall extending radially between the inner endwall and the outer endwall and spaced apart in a circumferential direction of the turbine engine. The inner and outer endwalls and the pressure and suction sidewalls define therewithin a duct for directing flow of a hot gas. Circumferentially adjacent flow directing structures mate along a respective split-line. The split-line extends along an interface between the pressure sidewall of a first flow directing structure and the suction sidewall of a second circumferentially adjacent flow directing structure. A composite airfoil structure is thereby defined, which includes a pressure sidewall formed by the pressure sidewall of the first flow directing structure and a suction sidewall formed by the suction sidewall of the second flow directing structure. The pressure and suction sidewalls of the airfoil structure extend between a leading edge and a trailing edge of the airfoil structure.

According a second aspect of the present invention, a flow directing structure for a turbine stator stage is provided. The flow directing structure comprises an inner endwall and an outer endwall spaced apart in a radial direction of a turbine engine, and a pressure sidewall and a suction sidewall extending radially between the inner endwall and the outer endwall and spaced apart in a circumferential direction of the turbine engine. The inner and outer endwalls and the pressure and suction sidewalls define therewithin a duct for directing flow of a hot gas.

### BRIEF DESCRIPTION OF THE DRAWINGS

The invention is shown in more detail by help of figures. The figures show preferred configurations and do not limit the scope of the invention.

FIG. 1 is a radial cross-sectional view of a conventional stator vane assembly;

FIG. 2 illustrates a CMC stator vane assembly in a view looking axially in the direction of flow of hot gas;

FIG. 3 is a radial cross-sectional view of along the section line of FIG. 2;

FIG. 4 illustrates flow directing structure according to a first embodiment of the present invention, in a view looking axially in the direction of flow of hot gas;

FIG. 5 is a radial cross-sectional view of along the section line V-V of FIG. 4;

FIG. 6 is a radial cross-sectional view of a flow directing structure according to a second embodiment of the present invention; and

FIGS. 7-11 illustrate multiple embodiments of the present invention depicting different configurations of the split-line between circumferentially adjacent flow directing structures.

### DETAILED DESCRIPTION

In the following detailed description of the preferred embodiments, reference is made to the accompanying drawings that form a part hereof, and in which is shown by way of illustration, and not by way of limitation, a specific embodiment in which the invention may be practiced. It is to be understood that other embodiments may be utilized and that changes may be made without departing from the spirit and scope of the present invention.

In the drawings, the direction A denotes an axial direction parallel to an axis of the turbine engine, while the directions R and C respectively denote a radial direction and a circumferential direction with respect to said axis of the turbine engine.

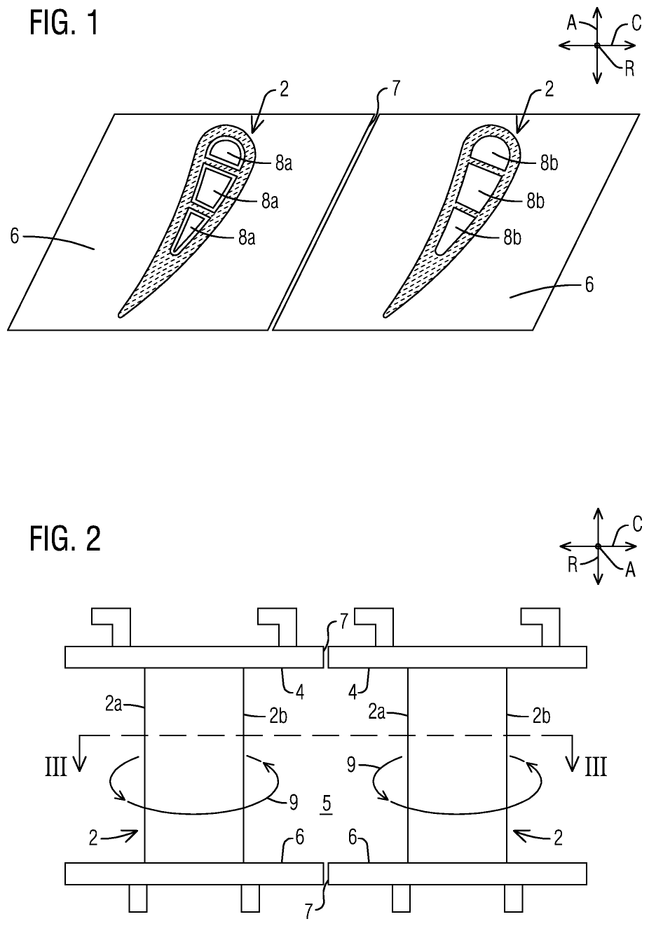

Conventionally, standard vanes, such as the example shown in FIG. 1, have been used in a turbine stator stage to turn and accelerate flow of a hot gas toward a downstream rotor stage. In this context, a standard vane refers to a unitary stator segment comprising at least one airfoil structure positioned between an inner shroud segment and an outer shroud segment. A standard vane typically has a metallic construction, being formed, for example, of a superalloy, such as a nickel based superalloy, and coated with a thermal barrier coating. It has been seen that by changing the base material from a nickel based superalloy to a CMC material, it is possible to significantly reduce the coolant air requirements of vane components. As previously stated, the above benefit arises from the fact that a CMC material can typically operate at higher temperatures than nickel based superalloys.

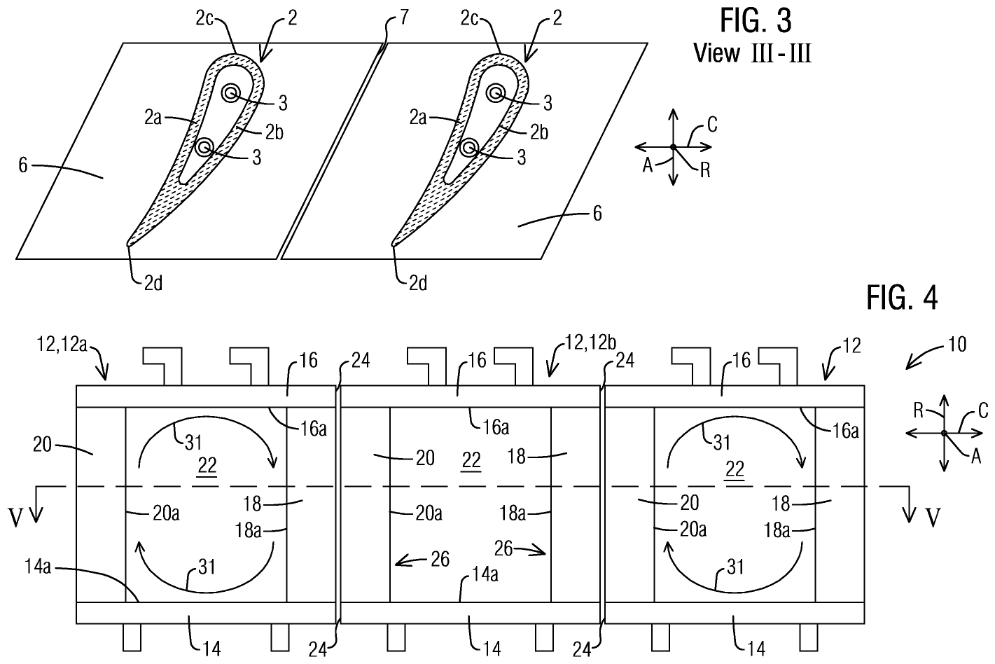

FIG. 2 and FIG. 3 illustrate an example configuration of a CMC stator vane assembly. As in the case of a standard vane, the example CMC stator vane assembly may be made up of circumferential stator segments with each stator segment comprising one or more airfoil structures 2 extending between an outer shroud segment 4 and an inner shroud segment 6. Each stator segment including the airfoil structure 2 and the outer and inner shroud segments 4, 6 may be formed of a metallic substructure, for example, formed by casting or other processes, over which a CMC material is aid up or assembled. In the example configuration, the airfoil structure is monolithically formed, comprising a pressure sidewall 2a and a suction sidewall 2b, which extend between a leading edge 2c and a trailing edge 2d of the airfoil structure 2. By using a CMC material, active cooling requirements may be significantly reduced, and in many cases, the stator segment may be sufficiently cooled by passive cooling such as radiation and/or natural convection. This may be particularly applicable for aft turbine stator stages, for example row 3 or row 4 vanes, in which the hot gas is significantly cooler than in the forward stages. At such locations, it may be possible that the operating temperature of the components is such that a passive cooling may sufficiently cool the components. In the shown example, as seen in FIG. 3, the stator segments are provided with coolant tubes 3 located internal to the airfoil structure 2, through which a coolant, such as compressor bleed air, is supplied from an outer diameter through the inner diameter of the stator segment. This coolant may be supplied, for example, to inter-stage seal housings and/or to purge a rotor cavity. Alternately, coolant may also be supplied from the inner diameter through the outer diameter of the stator segment. In addition to providing a radiative heat sink for the CMC airfoil, the coolant tubes 3 may also be structurally configured to carry the mechanical load of the hardware hanging under the stator segment.

The stator segments are arranged circumferentially adjacent to each other to form a stator stage. Circumferentially adjacent stator segments mate along a split-line 7 located at the circumferential edges of the outer and inner shroud segments 4, 6. The split-line 7 is typically located about mid-way between adjacent airfoil structures 2. As shown in FIG. 2, the volume between adjacent airfoils 2 forms a flow duct 5 that suitably directs the flow of hot combustion gases toward a row of rotating turbine blades downstream of the stator stage.

It has been seen that although it is fairly straightforward to cast large vane components using the current base materials, manufacturing an airfoil shape out of a CMC material is much more challenging. In addition, it has also been observed that CMC airfoil structures typically tend to have large diameters at the trailing edge, which may negatively affect aerodynamic efficiency of the airfoil. The present inventors have devised a unique configuration for a flow directing structure for a stator stage. Embodiments of the present invention address one or more of the above mentioned technical problems and provide numerous other benefits as described below. An underlying idea herein is a change in paradigm, from a monolithic airfoil structure with pressure and suction sidewalls, to a unitary flow directing structure comprising circumferentially spaced pressure and suction sidewalls, whereby the pressure sidewall of one flow directing structure pairs with a suction sidewall of an adjacent flow directing structure, to form a composite airfoil structure. The end result will still be a circumferential row of airfoil structures as in case of a standard vane assembly. However, instead of having the split-line between adjacent segments extending along the shroud mate-face, about mid-way between adjacent airfoils, the split-line in this case would extend through the composite airfoil structure.

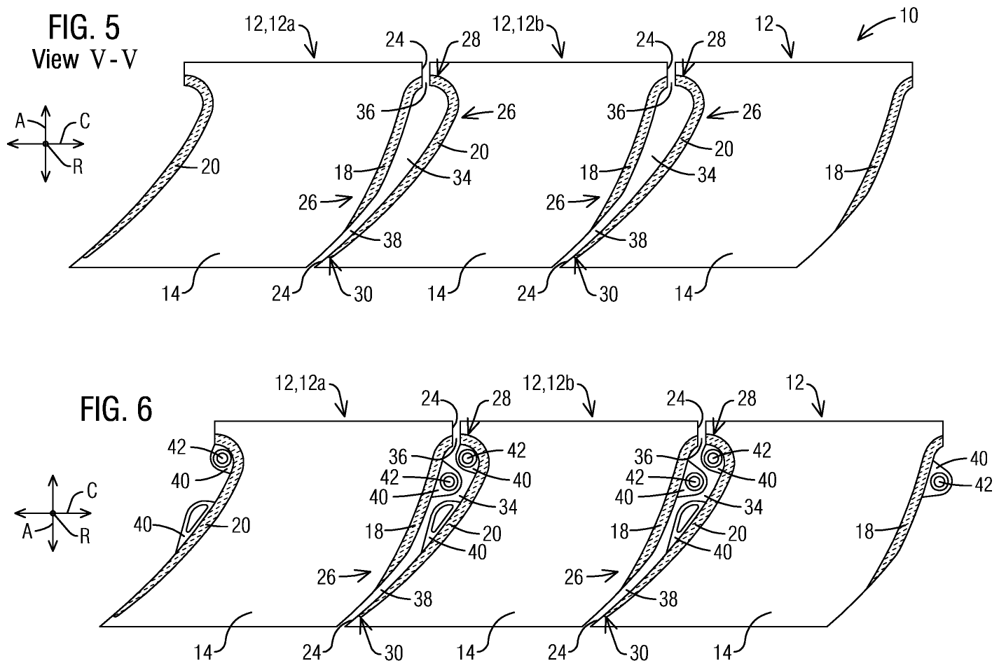

An embodiment of the present invention is now illustrated referring to FIG. 4 and FIG. 5. As shown, a stator stage 10 comprises a plurality of discrete flow directing structures 12. Each flow directing structure 12 includes an inner platform or an inner endwall 14 and an outer platform or an outer endwall 16, which are spaced in a radial direction of the turbine engine to respectively define an inner diameter and an outer diameter of the flow path of a hot gas. The inner and outer endwalls 14, 16 may thereby be arc-shaped along the circumferential direction of the turbine engine. Each flow directing structure 12 further includes a first sidewall 18 and a second sidewall 20 spaced apart in the circumferential direction of the turbine engine. The flow directing structure 12 thus formed, including the inner and outer endwalls 14, 16 and the first and second sidewalls 18, 20, define therewithin a duct 22 (see FIG. 4) for directing flow of a hot gas. In relation to the hot gas in the duct 22, the first sidewall 18 may define a relatively high pressure surface while the second sidewall 20 may define a relatively low pressure surface. Accordingly, the first sidewall 18 may be referred to as a pressure sidewall 18 of the flow directing structure 12, while the second sidewall 20 may be referred to as a suction sidewall of the flow directing structure 12. In the illustrated embodiment, the pressure sidewall 18 is concave while the suction sidewall 20 is convex in relation to the hot gas in the duct 22.

In the illustrated embodiment, circumferentially adjacent stator segments or flow directing structures 12a, 12b mate along a respective split-line 24 which extends along an interface between the pressure sidewall 18 of a first flow directing structure 12a and the suction sidewall 20 of a second circumferentially adjacent flow directing structure 12b. The first and second flow directing structures 12a, 12b mate to form a composite airfoil structure 26, which comprises a pressure sidewall 18 formed by the pressure sidewall 18 of the first flow directing structure 12a, and a suction sidewall 20 formed by the suction sidewall 20 of the second flow directing structure 12b. The pressure and suction sidewalls 18, 20 of the airfoil structure 26 extend at least partially between a leading edge 28 and a trailing edge 30 of the airfoil structure 26.

The illustrated embodiment is thus distinct from a standard stator segment which comprises one or more complete airfoil structures extending between an inner and an outer shroud segment. Resultantly, while in a standard stator stage (see FIGS. 1-3), the split-line 7 between a pair of circumferentially adjacent stator segments extends along the mate-face of the shroud segments 4,6 about mid-way between adjacent airfoils 2, in the illustrated embodiment (see FIGS. 4-5), the split-line 24 extends through the composite airfoil structure 26. The proposed concept of forming a stator stage with split-lines through the airfoil structure leads to a significant reduction of the mate-face length along the inner and outer endwalls 14, 16 that need to be sealed, which helps reduce leakage flow and further drives down coolant consumption in the stator stage.

In the illustrated embodiment, each of the flow directing structures 12 is formed of a CMC material, for example but not limited to an oxide-oxide CMC, a SiC—SiC CMC, among others. In particular, the CMC material may form at least the respective hot gas exposed surfaces 14a, 16a, 18a, 20a (see FIG. 4) respectively of the inner and outer endwalls 14, 16 and the pressure and suction sidewalls 18, 20 that define the duct 22 of the flow directing structure 12. A technical feature of the proposed configuration lies in the fact that it is no longer necessary to have the CMC material laid-up or assembled around an airfoil structure as schematically shown by the arrow 9 in the configuration of FIG. 2, which poses a manufacturing challenge, at least at the junction of the airfoil structure 2 and the outer and inner shroud segments 4, 6. In contrast to the above configuration, the proposed configuration makes it possible to lay-up plies of the CMC material in a continuous fashion to form a box-structure defining the inner periphery i.e. hot gas exposed surfaces 14a, 16a, 18a, 20a of the flow directing structures 12 that define the gas path volume of the duct 22, as shown schematically by the arrow 31 in FIG. 4. The lay-up sequence may, for example, be in the direction of the arrow 31, i.e., clock-wise from the parts 18 to 14 to 20 to 16, or vice versa. Such a lay-up may be achieved by relatively simple internal tooling means, for example using a negative mold representing the gas path volume of the duct 22. The proposed box configuration of allows the flow directing structure 12 to be formed by the CMC material in a way that aids manufacturability and longevity.

In one embodiment, the flow directing structure 12, including the inner and outer endwalls 14, 16 and the first and second sidewalls 18, 20 comprises a metallic substructure, which may be designed to carry the mechanical load on the stator components. The metallic substructure may be formed, for example, by casting, or any other process. Subsequently, a CMC skin is assembled over the metallic substructure to define the hot gas exposed surfaces 14a, 16a, 18a, 20a, which form the inner periphery of the flow directing structure 12. The CMC skin may be manufactured as a box-structure by laying up plies of CMC material in a continuous fashion as described above, before being assembled over the metallic substructure. In alternate embodiments, instead of using a metallic substructure, one or more of the first and second sidewalls 18, 20 and/or one or more of the inner and outer endwalls 14, 16 may be formed entirely out of a CMC material with a desired thickness for providing mechanical support to the stator components.

The illustrated configuration of the flow directing structure makes it possible to reduce the trailing edge thickness of the airfoil structure, thereby enhancing aerodynamic performance of the airfoil structure. This may be achieved by cutting back either the pressure sidewall or the suction sidewall from the trailing edge of the airfoil structure. In the embodiment shown in FIG. 5, the pressure sidewall 18 of the first flow directing structure 12a is cutback from the trailing edge 30 of the composite airfoil structure 26, to reduce the trailing edge thickness. A similar effect may be achieved, alternately, by cutting back the suction sidewall 20 of the second flow directing structure 12b from the trailing edge 30 of the composite airfoil structure 26. The proposed configuration thus addresses an existing problem with CMC airfoils, which typically tend to have large diameters at the trailing edge, which may negatively affect aerodynamic efficiency of the airfoil.

Referring to FIG. 5, the airfoil structure 26 may comprise an internal cavity 34 defined between the pressure sidewall 18 of the first flow directing structure 12a and the suction sidewall 20 of the second flow directing structure 12. In contrast to a standard monolithic airfoil, in the illustrated embodiment, the airfoil structure 26 comprises a first gap 36 at the leading edge 28 and a second gap 38 at the trailing edge 30. The first and second gaps 36, 38 are formed along a split-line interface of the pressure sidewall 18 of the first flow directing structure 12a and the suction sidewall 20 of the second flow directing structure 12b.

Aspects of the present invention may be directed toward airfoil structures, both, which require active cooling such as in a forward stator stage (e.g., stator row 1 or row 2) and which do not require active cooling such as in an aft stators stage (e.g., stator row 3 or row 4).

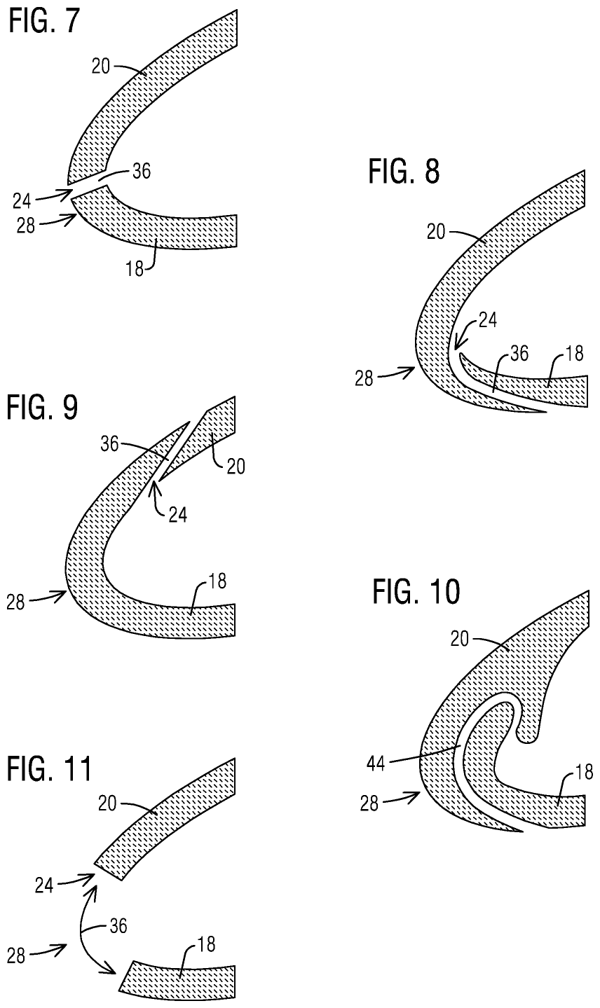

In one embodiment, the interface gaps 36 and 38 may be sealed by pressurizing the internal cavity 34 by a fluid. The pressurizing fluid, which in this example comprises compressed air from the compressor section, may be part of a secondary air system (SAS), which routes compressor air from an outer diameter of a turbine casing toward an inner diameter thereof, for example to supply compressor air to the inter-stage seal housings, U-rings, rotor purge cavity, etc. In this case, the pressurizing fluid in the internal cavity 34 of the airfoil structure 26 is not primarily meant for active cooling of the pressure and suction sidewalls 18, 20, but essentially for leakage control by sealing the gaps 36, 38 at the leading and trailing edges 28, 30 of the airfoil structure 26. The pressure of the pressurizing fluid may be configured so as to maintain a positive outflow margin at the first and second gaps 36, 38 in relation to the hot gas flow external to the airfoil structure 26, to thereby prevent an ingestion of the hot gas into the internal cavity 34. Pressurized air, which exits the gaps 36, 38 at the leading and trailing edge interfaces may offer cooling benefits to those regions in the form of backside cooling as well as film cooling. If no SAS requirement exists, the hot gas path may be sealed radially inboard or outboard of the interfaces between adjacent flow directing structures 12. In order to minimize hot gas ingestion through the gaps 36, 38 at the leading and trailing edges 28, 30, the split-line 24 may be moved toward the pressure or suction sidewalls 18, 20. Additionally, a type of sealing mechanism may be formed at the leading and/or trailing edge interfaces. These and other embodiments are illustrated later in connection with FIGS. 7-11.

In an alternate embodiment, the interface gaps 36, 38 at the leading edge 28 and the trailing edge 30 may allow hot gas ingestion into the internal cavity 34 of the airfoil structure 26. Such an embodiment may be applicable, for example, in an aft stator stage. An example is depicted in FIG. 6, in which the pressure sidewall 18 of the first flow directing structure 12a and the suction sidewall 18 of the second flow directing structure 12b comprise one or more hollow pockets 40 extending into the internal cavity 34 of the airfoil structure 26. The pockets 40 may be formed of a CMC material and may extend span-wise (i.e., radially) between the inner and outer endwalls 14, 16. The pockets 40 on the pressure sidewall 18 and the suction sidewall 20 may be staggered in the chord-wise direction of the airfoil structure 26 to define an internal passage for the hot gas which is ingested through the interface gap 36 at the leading edge 28 and ejected through the interface gap 38 at the trailing edge 30. As shown, each of hollow pockets 40 includes a coolant passage 42 therethrough for conducting a coolant, such as compressor air, radially between the inner and outer endwalls 14, 16. In the illustrated example, the coolant passages 42 are formed by inserting coolant tubes 42 through the CMC pockets. By creating pockets 40 on the sidewalls 18, 20 for the coolant tubes to run through, it may be possible to employ load carrying strut tubes as the coolant tubes 42 for very complex 3D aero shapes, which might not be possible for a standard vane component. The strut tubes 42 may be configured to carry the mechanical loads, for example, gravitational and aerodynamic loads, on the stator segment. In other embodiments, the use of a coolant tube may be obviated and the hollow CMC pockets 42 themselves may define the coolant openings.

The CMC pockets 40 protect the coolant tubes 42 from the high temperature of the ingested hot gas. By allowing the hot gas to travel though the airfoil 26 by entering at the stagnation region at the leading edge 28 and exiting at the trailing edge cutback, it is ensured that wakes produced by the airfoil structure 26 are filled by the ingested hot gas. Furthermore, the hot gas ingestion would also help reduce thermal fight in the airfoil structure 26 as both the “hot” and “cold” side of both the CMC sidewalls 18, 20 will now be exposed to the hot gas. Additional cooling benefits may be realized through such leakages in the form of backside cooling as well as film cooling.

FIGS. 7-11 illustrate multiple embodiments of the present invention depicting different configurations of the split-line between circumferentially adjacent flow directing structures. FIG. 7 illustrates an embodiment in which the split-line 24 extends along a mean camber line of the airfoil structure 26, forming a small interface gap 36 located at the center of the leading edge 28. In alternate embodiments, the split-line 24 may be offset from the mean camber line of the airfoil structure 26 toward the pressure sidewall 18 (FIG. 8) or toward the suction sidewall 20 of the airfoil structure 26 (FIG. 9). As a result, the interface gap 36 at the leading edge 28 would be correspondingly offset toward the pressure sidewall 18 or the suction sidewall 20 of the airfoil structure 26. The embodiment of FIGS. 8 and 9 provide that the split plane is shifted from the stagnation point at the leading edge, which minimizes hot has ingestion through the interface gap 36 at the leading edge 28. In yet another embodiment as illustrated in FIG. 10, the split-line interface at the leading edge 28 may include a ship-lapped interface 44. Such a ship-lapped or interlocking interface 44 serves to discourage through flow of hot gas and acts as a sealing mechanism against hot gas ingestion. An alternate embodiment is illustrated in FIG. 11, in which the interface gap 36 at the leading edge 28 may be designed to be large enough to encourage through flow of hot gas into the airfoil structure 26 (in contrast to FIG. 7). In this case, the interface gap 36 may preferably cover the stagnation point at the leading edge 28 to aid hot gas ingestion.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. A stator stage of a turbine engine, comprising:
a circumferential row of flow directing structures each flow directing structure comprising:
an inner endwall and an outer endwall spaced apart in a radial direction of the turbine engine, and
a pressure sidewall and a suction sidewall extending radially between the inner endwall and the outer endwall and spaced apart in a circumferential direction of the turbine engine,
wherein the inner and outer endwalls and the pressure and suction sidewalls define therewithin a duct for directing flow of a hot gas,
wherein circumferentially adjacent flow directing structures mate along a respective split-line which extends along an interface between the pressure sidewall of a first flow directing structure and the suction sidewall of a second circumferentially adjacent flow directing structure,
whereby a composite airfoil structure is defined, comprising:
a pressure sidewall formed by the pressure sidewall of the first flow directing structure and a suction sidewall formed by the suction sidewall of the second flow directing structure, the pressure and suction sidewalls of the airfoil structure extending between a leading edge and a trailing edge of the airfoil structure.

2. The stator stage according to claim 1, wherein at least one of the flow directing structures is formed of a ceramic matrix composite material.

3. The stator stage according to claim 2, wherein the ceramic matrix composite material forms respective hot gas exposed surfaces of the inner and outer endwalls and the pressure and suction sidewalls that define the duct of the at least one flow directing structure.

4. The stator stage according to claim 3, wherein said hot gas exposed surfaces of the flow directing structure are formed by a continuous lay-up of the ceramic matrix composite material along an inner periphery of the flow directing structure that forms a boundary of a gas path volume of the duct.

5. The stator stage according to claim 1, wherein either one of the pressure sidewall of the first flow directing structure or the suction sidewall of the second flow directing structure is cutback from the trailing edge of the composite airfoil structure.

6. The stator stage according to claim 1, wherein the split-line extends along a mean camber line of the airfoil structure.

7. The stator stage according to claim 1, wherein the airfoil structure comprises an internal cavity defined between the pressure sidewall of the first flow directing structure and the suction sidewall of the second flow directing structure.

8. The stator stage according to claim 7, wherein the airfoil structure comprises a first gap at the leading edge and a second gap at the trailing edge, the first and second gaps being formed along a split-line interface of the pressure sidewall of the first flow directing structure and the suction sidewall of the second flow directing structure.

9. The stator stage according to claim 8, wherein the split-line is offset from a mean camber line of the airfoil structure toward the pressure sidewall or the suction sidewall of the airfoil structure, such that the first gap at the leading edge is correspondingly offset toward the pressure sidewall or the suction sidewall of the airfoil structure.

10. The stator stage according to claim 8, wherein the split-line interface at the leading edge includes a ship-lapped interface.

11. The stator stage according to claim 8, wherein the internal cavity of the airfoil structure is pressurized by a fluid to maintain a positive outflow margin at the first and second gaps in relation to a hot gas flow external to the airfoil structure.

12. The stator stage according to claim 8, wherein the first and second gaps are configured to allow hot gas ingestion into the internal cavity of the airfoil structure.

13. The stator stage according to claim 12, wherein the pressure sidewall of the first flow directing structure and or the suction sidewall of the second flow directing structure comprises one or more hollow pockets extending into the internal cavity of the airfoil structure,
wherein at least one of the hollow pockets includes a coolant passage therethrough for conducting a coolant radially between the inner and outer endwalls.

14. The stator stage according to claim 12, wherein the coolant passage is formed by coolant tubes inserted through the respective hollow pocket.

15. The stator stage according to claim 12, wherein one or more hollow pockets are formed of a ceramic matrix composite material.

16. A flow directing structure for a turbine stator stage, comprising:
an inner endwall and an outer endwall spaced apart in a radial direction of a turbine engine, and
a pressure sidewall and a suction sidewall extending radially between the inner endwall and the outer endwall and spaced apart in a circumferential direction of the turbine engine,
wherein the inner and outer endwalls and the pressure and suction sidewalls define therewithin a duct for directing flow of a hot gas.

17. The flow directing structure according to claim 16, wherein the flow directing structure is formed of a ceramic matrix composite material.

18. The flow directing structure according to claim 17, wherein the ceramic matrix composite material forms respective hot gas exposed surfaces of the outer and inner endwalls and the pressure and suction sidewalls that define the duct of the flow directing structure.

19. The flow directing structure according to claim 18, wherein said hot gas exposed surfaces of the flow directing structure are formed by a continuous lay-up of the ceramic matrix composite material along a boundary of a gas path volume of the duct.

20. The flow directing structure according to claim 16, wherein the flow directing structure is configured to mate with circumferentially adjacent flow directing structures on either side along a respective split line, such that each split-line extends along an interface between one of the pressure or suction sidewalls of said flow directing structure and a corresponding other of the pressure or suction sidewalls of the circumferentially adjacent flow directing structure on either side.
